(19) United States
(12) Patent Application Publication
(10) Pub. No.: US 2021/0319395 A1
(43) Pub. Date: Oct. 14, 2021

(54) Method for Making a Purchase

(71) Applicant: Daimler AG, Stuttgart (DE)

(72) Inventors: Christoph GAENG, Stuttgart (DE); Markus KUTSCHKE, Stuttgart (DE)

(73) Assignee: Daimler AG, Stuttgart (DE)

(21) Appl. No.: 17/261,495

(22) PCT Filed: Jul. 15, 2019
(86) PCT No.: PCT/EP2019/068954

§ 371 Date: Jan. 19, 2021

(30) Foreign Application Priority Data
Jul. 20, 2018 (DE) 10 2018 005 760.8

(51) Int. Cl. G06Q 10/08; G06Q 30/06; B60L 53/14

(52) U.S. Cl. CPC G06Q 10/0832; B60L 53/14; G06Q 30/0633; G06Q 10/08355

(57) ABSTRACT

A method for making a purchase includes relaying by a user of a vehicle a shopping list to the vehicle, sending by the vehicle a shopping request corresponding to the shopping list to a sales facility or a plurality of sales facilities, and delivering by at least one sales facility an item listed on the shopping list to the vehicle. The sending is only done when the vehicle is at a standstill.

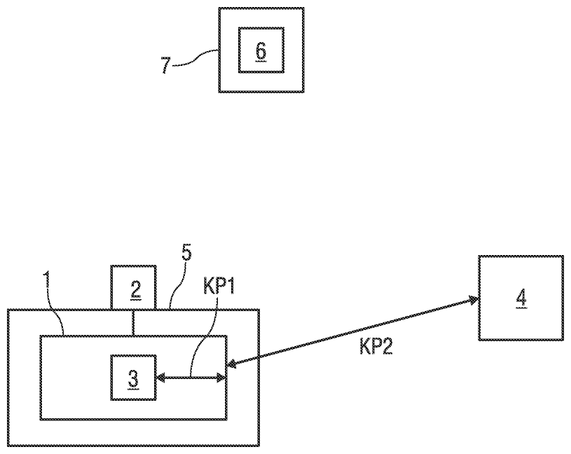

### BACKGROUND AND SUMMARY OF THE INVENTION

The invention relates to a method for making a purchase.

From the prior art, as described in US 2015/0356665 A1, an advance purchase mechanism for autonomous vehicles is known. An on-board computer device of the autonomous vehicle interacts with computers that are used by one or more retailers in order to make it possible for users to buy articles from the one or more retailers in advance, while they are on the way to a destination by means of the autonomous vehicle. The computer of the retailer can send a purchase confirmation to the on-board computer device of the user which shows where the autonomous vehicle of the user should park and/or where the items purchased in advance are being held ready for collection.

A method and a system for an autonomous or semi-autonomous delivery are described in WO 2017/064202 A1. The method comprises the provision of a system comprising at least one server, at least one robot and at least one delivery terminal. The method further comprises transmitting a request to the at least one server and/or to the at least one robot for at least one delivery by the at least one delivery terminal, providing instructions from the at least one server to the at least one robot about the at least one delivery, wherein the instructions comprise information about the final delivery destination, loading the at least one robot with the at least one delivery to be transported, transporting the at least one delivery in the at least one robot to the final delivery destination, and providing access to the at least one delivery in the at least one robot, preferably when arriving at the delivery destination.

The object of the invention is to specify an improved method for making a purchase in comparison to the prior art.

In a method for making a purchase, a user of a vehicle relays a shopping list to the vehicle, wherein the vehicle sends at least one shopping request corresponding to the shopping list to a sales facility or several sales facilities, and wherein at least one sales facility delivers at least one of the goods listed on the shopping list to the vehicle.

According to the invention, the vehicle sends the at least one shopping request corresponding to the shopping list to the sales facility or several sales facilities only when at a standstill, in particular only when the vehicle is parked.

In this way, the user of the vehicle has gained additional time which they can use for other purposes since they do not have to go shopping themselves. For example, they can leave the parked vehicle and do other things and find their shopping when they return to the vehicle. In particular, it is not necessary for the customer to figure out which sales facility, for example which supermarket, they have to get goods from and which sales facility has what range available. The delivery takes place quickly and comfortably, in particular while the vehicle is parked.

In the method described here, the shopping request is thus not carried out by the user, but rather it is carried out by the vehicle, in particular automatically, by means of the shopping list relayed to the vehicle by the user.

As a result of the vehicle sending the at least one shopping request corresponding to the shopping list to the sales facility or the several sales facilities only when at a standstill, in particular only when the vehicle is parked, the position at which the at least one item listed on the shopping list or the several items listed on the shopping list is/are advantageously to be delivered is advantageously already known to the vehicle, or this position can advantageously be ascertained by the vehicle, in particular by means of a corresponding position determination device of the vehicle, in particular by using at least one global navigation satellite system and/or a different method. In a possible embodiment, this position, i.e., the position at which the vehicle has come to a standstill, in particular is parked, and from which the vehicle sends the at least one shopping request corresponding to the shopping list to the sales facility or the several sales facilities, is thus sent from the vehicle to the sales facility or the several sales facilities together with the at least one shopping request corresponding to the shopping list. Thus, it is not necessary, for example, for the user to communicate the position to which the delivery should take place to the vehicle, but rather the vehicle must only relay the shopping list to the vehicle; everything else is advantageously carried out automatically by the vehicle. In particular, the vehicle automatically sends the al least one shopping request corresponding to the shopping list only when it has come to a standstill, in particular only when it is parked, and, as described, advantageously also its position. However, alternatively, it could also be provided that, in addition to the shopping list, the user then additionally sends the position relayed to the vehicle to which the delivery is to take place. Then, it is advantageously provided that the vehicle, as described above, automatically sends the at least one shopping request corresponding to the shopping list only when it has come to a standstill, in particular only when it is parked, and then advantageously also the position relayed by the user to the vehicle to which the delivery is to take place.

In a possible embodiment, the vehicle has at least one traction battery that can be charged by means of an electrical charging device external to the vehicle, i.e., an energy store for storing electrical energy for at least one drive engine for driving the vehicle, and only sends the at least one shopping request corresponding to the shopping list to the sales facility or the several sales facilities when the vehicle is parked in order to charge the at least one traction battery on an electrical charging device external to the vehicle. In particular, the vehicle only sends the at least one shopping request corresponding to the shopping list to the sales facility or the several sales facilities when the vehicle is electrically connected to the electrical charging device external to the vehicle in order to charge the at least one traction battery. In this way, a required charging time for charging the at least one traction battery of the vehicle is particularly effectively used, since this charging time is simultaneously used as shopping time, such that additional shopping time is not required.

In particular, the vehicle is stationary in a position at which it sends the at least one shopping request corresponding to the shopping list to the sales facility or the several shopping facilities until the delivery of the at least one item, and it sends this position to the sales facility or the several sales facilities together with the shopping request. This is particularly advantageous during the charging time for charging the traction battery since this charging time takes a relatively long period of time which, up until now, could not be used for anything meaningful, yet which is sufficient for carrying out this method, i.e., in particular for ordering and delivering one or more items.

In a possible embodiment, in the event of offers arriving from several sales facilities, the vehicle performs a prioritization, in particular a prioritization of the offers arriving, for example in terms of cost and/or delivery time. For example, the vehicle selects the sales facility which offers the items most cheaply and/or can deliver to the vehicle within a predetermined time, in particular within the charging time, and it correspondingly orders from this sales facility.

In a possible embodiment, the sales facility sends a confirmation to the vehicle before the delivery of the at least one item. Thus, the sales facility confirms they are delivering the item, such that a premature removal of the vehicle from the specified position at which the item is to be delivered can be avoided.

In a possible embodiment, the at least one sales facility delivers the at least one item listed on the shopping list to the vehicle by means of a drone or by means of a delivery person. For example, the drone can be formed as a flying and/or driving drone. In particular with a delivery by such a drone, human effort for the delivery is correspondingly low.

The drone is sent out from the vehicle or from the at least one sales facility, for example. That is to say, the drone belongs to the sales facility, for example, and is sent out from this in order to deliver the items to the vehicle, or the vehicle has its own drone in order to collect the purchased items, such that the vehicle's own drone takes over the delivery. With the vehicle's own drone, the at least one sales facility thus makes use of this drone belonging to the vehicle to deliver the at least one item listed on the shopping list to the vehicle, i.e., the at least one sales facility delivers the at least one item listed on the shopping list to the vehicle by means of the drone of the vehicle. As a result of this use of the vehicle's own drone, for example, sales facilities that themselves do not have their own drone and with which a delivery in another manner would not be possible, for example in relation to the required delivery time, can also deliver goods to the vehicle. Thus, a number of sales facilities coming into consideration is increased, such that the probability of the respective item being able to be delivered is higher, and, in addition, cost advantages of different sales facilities can be used.

In a possible embodiment, the drone is authenticated when the delivery is carried out by the drone or the delivery person when the delivery is carried out by the delivery person by means of an authentication code transmitted from the vehicle to the at least one sales facility or by means of other access data relating to the vehicle in order to enable at least one closing element, in particular a boot lid, to be opened and to deposit the at least one item in the vehicle. In particular, the vehicle is locked again after depositing the at least one item. If the delivery is carried out by the delivery person, then it can be provided, for example, that the delivery person themselves opens and/or closes the at least one closing element, for example the boot lid, such that only the unlocking and locking is carried out by the vehicle. Alternatively, in particular when using the drone for the delivery, opening and/or closing the at least one closing element is carried out by the vehicle. As a result of this authentication, the vehicle, in particular only its boot, is temporarily opened only during the delivery of the at least one item, that is to say only for authorized people or facilities, i.e., only for the authenticated delivery person or drone, such that the delivered purchase and other articles are securely stored in the vehicle.

After depositing the at least one item, the drone is moved for example to a predetermined drone parking position, in particular to a drone charging station, in particular to a predetermined drone parking position of the vehicle or the sales facility. The drone parking position is thus advantageously a drone charging station where the electromotively operated drone, for example, can be recharged. If the drone belongs to the sales facility, the drone is moved back there to its drone parking position. If the drone belongs to the vehicle, then the drone returns to its drone parking position, in particular drone charging station, on the vehicle and is advantageously anchored there, such that it is arranged on the vehicle. Alternatively, it can also be provided, for example, that the drone is allocated to the electrical charging device external to the motor vehicle and is correspondingly moved back to its drone parking position, in particular drone charging station, on the electrical charging device external to the vehicle.

The user compiling the shopping list and/or the user relaying it to the vehicle can be carried out by means of a speech assistance system, for example, in the vehicle, in particular by means of speech input by the user. For example, it can be provided that an interior microphone or several interior microphones of the vehicle record/records words spoken by the user in the vehicle and transmit these, in particular by means of radio technology, for example via mobile radio and/or Wi-Fi, to at least one in particular central device external to the vehicle, for example to at least one server external to the vehicle, in particular to a Cloud service. The Cloud service can be a component of at least one server external to the vehicle of a manufacturer of the vehicle, for example, in particular a vehicle backend, or this vehicle backend supports the transmission to this Cloud service. Here, i.e., in the in particular central device external to the vehicle, for example in the server external to the vehicle, in particular the Cloud service, the input, i.e., the words spoken by the user, is processed, and the shopping list is compiled. This shopping list is transmitted back to the vehicle, advantageously via the same log and/or the same technology.

Alternatively or additionally, it can be provided, for example, that the user compiles the shopping list on a mobile terminal, for example on a mobile telephone, in particular a smartphone, and/or on a tablet computer. The user then transmits the shopping list from this mobile terminal to the vehicle. This can be carried out by a wireless or wire-bound transmission, for example. For example, one or more radio technologies, in particular Bluetooth and/or Wi-Fi and/or infrared transmission can be used as the wireless transmission from the mobile terminal to the vehicle.

Alternatively or additionally, the compilation of the shopping list by the user and/or the transmission thereof to the vehicle by the user can be carried out, for example, via at least one input interface of the vehicle, for example via a display device with input capability in the vehicle, for example via a touch-sensitive display of the vehicle. The transmission of the shopping list by the user can then be carried out by a corresponding input of the user via this input interface of the vehicle.

For example, it can be provided that an online service synchronization, in particular by a push upgrade, synchronously and in an up-to-date manner retains the shopping list of the mobile terminal/mobile terminals, the vehicle and the Cloud service.

The vehicle sending the at least one shopping request corresponding to the shopping list to the sales facility or the several sales facilities can be carried out by means of an internet-based Cloud service, for example, which makes contact with the sales facility or with the several sales facilities by means of the internet and receives offers. If this is carried out according to the exemplary embodiment described above when the vehicle is parked to charge the at least one traction battery on the electrical charging device external to the vehicle, in particular when the vehicle is electrically connected to the electrical charging device external to the vehicle for charging the at least one traction battery, the vehicle can then communicate with this Cloud service, for example by Ethernet, in particular by the electrical charging device external to the vehicle with the transmitter. Alternatively or additionally, a radio technology system of the vehicle, in particular mobile radio in the vehicle, can be used, for example by means of a SIM card installed in the vehicle, for the internet-based communication with the Cloud service. This internet-based communication with the Cloud system is then carried out in particular via an internet provider which makes this internet-bed communication possible via mobile radio.

With the delivery described above of the at least one item listed on the shopping list by means of a drone, an orientation of the drone can be carried out, in particular for carrying out its movement, in particular flight movement, and/or a detection of the position to which delivery is to be made, and/or a detection of the vehicle for example by means of at least one global navigation satellite system and/or by means of one or more sensors of the drone. As sensors, the drone has one or more cameras, for example, one or more ultrasonic sensors and/or one or more Lidar sensors. The correct identification of the vehicle to which delivery is to be made can be carried out by the drone, for example by means of a number plate recognition system, in particular by means of one or more cameras of the drone. The sensors of the drone here also enable a movement of the drone in a building, for example in a covered car park. When, for example, only the building is known as the position of the vehicle yet not the exact position of the vehicle in the building, for example, in particular not the respective parking level which the vehicle is on in the building, in particular a covered car park, then it can be provided, for example, that the drone finds the vehicle in the building by means of the number plate recognition system, i.e., it finds the vehicle in the building, wherein it is advantageously oriented by means of its sensors and identifies the vehicle by means of its number plate, for example.

In order to deposit the at least one item in the vehicle using the drone, it can be provided by way of example that the drone moves into the open vehicle, in particular into the boot, in particular flies in. Alternatively or additionally, it can be provided, for example, that the drone has a dropping mechanism which is released in order to convey the at least one item into the vehicle by dropping. In this way, it is not necessary for the drone to enter the vehicle. Triggering the dropping mechanism can be carried out by the drone and/or by the vehicle, for example.

Alternatively to depositing the at least one item in the vehicle using the drone or the delivery person, it can be provided by way of example that the at least one item is deposited onto or next to the vehicle by the drone or the delivery person. Thus, opening the vehicle, i.e., opening a closing element of the vehicle, is not necessary.

With the prioritization of the offers received described above, for example in addition or alternatively to the prioritization in terms of cost and/or delivery time, a prioritization in terms of the technical circumstances and/or technical requirements, for example, can optionally be carried out, in particular in terms of the type, load and/or range of the respectively used drone. This is advantageously requested with the respective sales facility, in particular automatically requested by the vehicle, for example. Thus, sales facilities whose respective drone does not correspond to the technical circumstances and/or technical requirements, is not taken into consideration, for example. The technical circumstances and/or technical requirements are based, for example, on a region where the vehicle is and thus in which the goods are to be delivered, and/or on a spacing of the sales facility to the vehicle and/or on a load required for the goods.

Exemplary embodiments of the invention are explained in more detail below by means of a drawing.

### BRIEF DESCRIPTION OF THE DRAWING

The FIGURE schematically illustrates a method for making a purchase.

### DETAILED DESCRIPTION OF THE DRAWING

The FIGURE shows a schematic depiction of a method for making a purchase. A vehicle 1 is depicted, in particular an electric vehicle or hybrid vehicle, which has at least one traction battery for storing electrical energy for at least one electrical drive engine for driving the vehicle 1, wherein this traction battery can be charged on an electrical charging device 2 external to the vehicle.

A user 3 of the vehicle 1 makes a shopping list, in particular during a journey of the vehicle 1, for example by inputting into a multimedia system of the vehicle 1 and/or a speech input, i.e., they relay this shopping list to the vehicle 1, schematically depicted by a first communication arrow KP1.

When the vehicle 1 comes to a standstill, in particular when the vehicle 1 is parked, the vehicle 1 sends at least one shopping request corresponding to the shopping list to a sales facility 4 or several sales facilities 4. For example, the user 3 parks the vehicle 1 on arrival at a target location, in particular in a parking space 5 with an electrical charging device 2 external to the vehicle, to charge the traction battery and connects it to the electrical charging device 2 external to the vehicle, for example to a charging column. Sending the at least one shopping request corresponding to the shopping list, in particular of a corresponding shopping order, by the vehicle 1 to a sales facility 4, for example to a supermarket, or several such sales facilities 4 is triggered, for example, by parking the vehicle 1 at the electrical charging device 2 external to the motor vehicle or by connecting the vehicle 1 to the electrical charging device 2 external to the vehicle. Advantageously, in addition to the shopping request, the vehicle 1 also sends its position, which it has ascertained for example by means of at least one global navigation system, and a verification code, also referred to as verification ID. This sending to one or more sales facilities 4 can be carried out directly, for example, or carried out indirectly, in particular via a device external to the vehicle, for example a device of a manufacturer of the vehicle 1, also referred to as vehicle backend.

For example, the vehicle 1 firstly sends the shopping request to the nearest sales facility 4. If the shopping request is present, the sales facility 4 advantageously provides acknowledgement as to whether a corresponding order for delivery of the shopping can be undertaken. This acknowledgement can also be carried out directly to the vehicle 1 or via the device external to the vehicle, for example the device of the manufacturer of the vehicle 1, in particular via the vehicle backend. Should a delivery by this nearest sales facility 4 not be possible, the vehicle 1 then sends this shopping request to at least one further shopping facility 4, for example, which then also provides a corresponding acknowledgement as to whether a corresponding order for delivery of the shopping can be undertaken. That is to say, the vehicle 1 checks the availability of a respective item 6 corresponding to the shopping request and orders with the sales facility 4 which can deliver the item 6. The communication between vehicle 1 and sales facility 4 is schematically depicted by a second communication arrow KP2,

Alternatively to this shopping request in the sequence of the removal of the respective sales facility 4 to the vehicle 1, it can be provided, for example, that the vehicle 1 sends the shopping request simultaneously or temporally offset to several sales facilities 4. In this case, the vehicle 1, along with checking the availability of the respective item 6, with offers arriving from several sales facilities 4, a prioritization is performed, i.e., one of the offers is selected, in particular according to predetermined criteria, for example depending on costs and/or delivery time.

The vehicle 1 accepts the offer of the sales facility 4 or one of the offers of several sales facilities 4, whereupon the sales facility 4 compiles the items 6 corresponding to the shopping request and delivers them to the vehicle 1, to the parked vehicle 1 and thus to the position which the vehicle 1 has communicated to the sales facility 4. Advantageously, the sales facility 4 also sends a corresponding confirmation to the vehicle 1 that the delivery will be carried out. As described above, sending this confirmation can be carried out directly to the vehicle 1 or indirectly via the device external to the vehicle, in particular via the vehicle backend.

As depicted here, the delivery can be carried out by a drone 7 or by a delivery person, in particular a courier.

In the event of a delivery by a delivery person, this delivery person is authorized in relation to the vehicle 1 by means of the verification code, for example using an app, i.e., a program on a mobile terminal, for example on a mobile telephone, in particular smartphone, of the delivery person or on a portable computer of the delivery person. The transmission of the verification code to the vehicle 1 can here be carried out by means of radio transmission, for example, for example by means of NFC (Near Field Communication) or Bluetooth, or by means of a different radio technology.

After authorizing in relation to the vehicle 1, a closing element of the vehicle 1 is unlocked by the vehicle 1, for example a boot lid of a boot of the vehicle 1, such that the delivery person can open it and can place the delivery, i.e., the at least one delivered item 6, in the vehicle 1, or the vehicle 1 itself opens the closing element in order to make it possible for the delivery person to deposit the at least one delivered item 6 in the vehicle 1. After depositing the at least one delivered item 6, the delivery person or the vehicle 1 itself closes the closing element, and the vehicle 1 is locked again.

Because of this unlocking of at least one closing element of the vehicle 1 after receiving the verification code, advantageously a radio technology with short range is used as the radio technology for transmitting the verification code, in particular with a range in the centimeter range or maximally in the meter range, i.e., with a range of a few centimeters or meters, for example with a range of up to a maximum of one meter or up to a maximum of three meters, for example NFC or Bluetooth, as mentioned above. It is thus ensured that the vehicle 1 is unlocked when the delivery person is in the immediate vicinity of the vehicle 1, such that access to the vehicle 1 for unauthorized third parties is prevented.

With a delivery by a drone 7, for example by a driving or flying drone 7, in particular by an unmanned, in particular automatically, in particular autonomously, moving means of transport, the drone 7 is also authorized in relation to the vehicle 1 by means of the verification code. Here, this transmission of the verification code from the drone 7 to the vehicle 1 is also carried out by means of the radio technology described above, for example, in particular by means of NFC or Bluetooth or a different radio technology with the low range described above in order to also enable the unlocking of the at least one closing element only when the drone 7 is in the immediate vicinity of the vehicle 1. After the authorization, the at least one closing element of the vehicle 1, in particular the boot lid of the boot, is unlocked and also opens automatically, such that the drone 7 can deposit the at least one delivered item 6 in the vehicle 1. After this, the vehicle 1 closes the at least one open closing element automatically and locks itself again.

The drone 7 is, for example, a drone 7 of the sales facility 4 or a drone 7 of the vehicle 1. In the first case, i.e., the drone 7 belongs to the sales facility 4, the drone 7 is sent out by the sales facility 4 and returns to the sales facility 4 after completing the delivery. In the second case, i.e., the drone 7 belongs to the vehicle 1, the delivery is thus carried out by this drone 7 of the vehicle 1, i.e., the drone 7 of the vehicle 1 is sent out by the vehicle 1, picks up the delivery, i.e., the at least one item 6 in particular ordered and purchased corresponding to the shopping list, from the sales facility 4 and delivers them to the vehicle 1. After depositing them in the vehicle 1, the drone 7 returns to a predetermined drone parking position, in particular drone charging position, of the vehicle 1 and is then anchored there, such that it is held securely on the vehicle 1 and recharged.

The method described enables a particularly comfortable purchase, since the user 3 can use the charging time required to charge the traction battery in another, more meaningful manner, and finds their shopping, i.e., the one or more items 6 on the shopping list, in the vehicle 1 when returning to the vehicle 1. Here, the user 3 does not have to think about which sales facility 4 they will get the items 6 from and which sales facility 4 has what range available. The delivery is carried out quickly and comfortably, advantageously while the traction battery of the vehicle 1 is charged and the vehicle 1 thus remains still in any case. Only during the delivery, in particular only for depositing the at least one item 6 in the vehicle 1 is the at least one closing element of the vehicle 1, in particular the boot lid of the boot, unlocked and temporarily opened, such that articles are safely stored in the vehicle 1, in particular also the at least one delivered item 6 in the vehicle 1.

1.-10. (canceled)

11. A method for making a purchase, comprising the steps of
relaying by a user of a vehicle a shopping list to the vehicle;
sending by the vehicle a shopping request corresponding to the shopping list to a sales facility or a plurality of sales facilities; and
delivering by at least one sales facility an item listed on the shopping list to the vehicle;
wherein the sending is only done when the vehicle is at a standstill.

12. The method according to claim 11, wherein the vehicle has a traction battery that is chargeable by an electrical charging device external to the vehicle and wherein during the standstill the vehicle is parked to charge the traction battery on the electrical charging device.

13. The method according to claim 12, wherein during the standstill the vehicle is electrically connected to the electrical charging device.

14. The method according to claim 11, wherein the vehicle remains stationary in a position in which the vehicle performs the sending until delivery of the item and wherein the vehicle sends the position together with the shopping request to the sales facility or the plurality of sales facilities.

15. The method according to claim 11 further comprising the step of performing a prioritization by the vehicle in an event of offers arriving from several of the plurality of sales facilities.

16. The method according to claim 11 further comprising the step of sending a confirmation to the vehicle by the at least one sales facility before the delivering,

17. The method according to claim 11 wherein the delivering is performed by a drone or a person.

18. The method according to claim 17, wherein the drone is sent from the vehicle or from the at least one sales facility.

19. The method according to claim 17 further comprising the steps of:
authorizing the drone or the person in relation to the vehicle by transmitting a verification code from the vehicle to the at least one sales facility in order to enable opening of a closing element and depositing of the item in the vehicle; and
locking the vehicle by the vehicle after the item is deposited in the vehicle.

20. The method according to claim 17 further comprising the step of moving the drone to a predetermined drone parking position after depositing the item in the vehicle.

21. The method according to claim 20, wherein the predetermined drone parking position is a drone charging station.
